(19) United States
(12) Patent Application Publication
(10) Pub. No.: US 2019/0157059 A1
(43) Pub. Date: May 23, 2019

(54) TRANSFER TUBE CALIBRATION

(71) Applicant: Micromass UK Limited, Wilmslow (GB)

(72) Inventors: Emrys Jones, Manchester (GB); Steven Derek Pringle, Temple, Hoddlesden, Darwen (GB)

(21) Appl. No.: 16/095,008

(22) PCT Filed: Apr. 19, 2017
(86) PCT No.: PCT/GB2017/051080

§ 371 Date: Oct. 19, 2018

(30) Foreign Application Priority Data
Apr. 19, 2016 (GB) 1606766.2

(51) Int. Cl. H01J 49/04; H01J 49/16

(52) U.S. Cl. CPC H01J 49/0422; H01J 49/16

(57) ABSTRACT

Disclosed herein is a method comprising liberating analyte material from a sample and transferring the liberated analyte material towards an inlet of an ion analyser via a sampling or transfer tube (202). The presence of the analyte material is detected at a first position by a detector (203), and this detection may be used to determine a transit time for the analyte material through at least a part of said sampling or transfer tube (202). The detector (203) may be disposed within the sampling or transfer tube (202).

### CROSS-REFERENCE TO RELATED APPLICATION

This application claims priority from and the benefit of United Kingdom patent application No. 1606766.2 filed on 19 Apr. 2016. The entire content of this application is incorporated herein by reference.

### FIELD OF THE INVENTION

The present invention relates generally to methods and systems of analysis, particularly to methods of mass spectrometry and systems for mass spectrometry.

### BACKGROUND

Rapid evaporative ionization mass spectrometry (“REIMS”) is a technology which has recently been developed for the real-time identification of substrates, for example for the identification of biological tissues during surgical interventions. Rapid evaporative ionization mass spectrometry (“REIMS”) analysis of biological tissues has been shown to yield phospholipid profiles having high histological and histopathological specificity, similar to Matrix Assisted Laser Desorption Ionisation (“MALDI”), Secondary Ion Mass Spectrometry (“SIMS”) and Desorption Electrospray Ionisation (“DESI”) imaging.

Coupling of rapid evaporative ionization mass spectrometry (“REIMS”) technology with handheld sampling devices has resulted in a sampling technology which can provide intra-operative tissue identification. This technology allows surgeons to resect target tissues more efficiently, such as tumours, intra-operatively by providing information that can assist a surgeon in minimizing the amount of healthy tissue removed whilst helping to resect the target tissue. The sampling technology can also be used by non-surgical operators in non-surgical procedures to isolate or analyse target matter from an in vitro substrate.

In a known sampling system, a mass spectrometric signal is obtained by subjecting a substrate to alternating electric current at radiofrequency which causes localized Joule-heating and the disruption of cells along with desorption of charged and neutral particles. The resulting aerosol (e.g. “surgical smoke”) is then transported to a mass spectrometer for on-line mass spectrometric analysis.

The recently developed rapid evaporative ionisation mass spectrometry (“REIMS”) technique has led to a number of real-time analysis applications in the field of mass spectrometry. Typically, rapid evaporative ionization mass spectrometry (“REIMS”) techniques involves contacting a sample to generate gaseous or aerosolised material which is then transferred to the mass spectrometer via a sampling or transfer tube. For example, one application is the analysis of smoke generated from a sample by an electrosurgical or laser probe to provide real-time information on the type of material being cut. Various other ambient pressure ionisation techniques exist which may also involve transferring analyte material via a sampling or transfer tube.

It is desired to provide an improved method of analysis.

### SUMMARY

According to an aspect there is provided a method of analysis comprising:

liberating analyte material from a sample;

transferring the analyte material towards an inlet via a sampling or transfer tube and transferring the analyte material through the inlet to an ion analyser; and

analysing the analyte material and/or ions derived from the analyte material at the ion analyser; and

detecting the presence of the analyte material at a first position;

the method further comprising:

determining a transit time of the analyte material through at least a part of the sampling or transfer tube using the detection at the first position and optionally a subsequent detection of the analyte material and/or of ions derived from the analyte material.

It has been recognised that the transit time of analyte material through a sampling or transfer tube positioned between a sample and the inlet to an ion analyser may be significant, particularly where for reasons of safety or space the ion analyser is situated remotely from the sample being analysed so that a relatively extended sampling or transfer tubing is required or where the sampling or transfer tube is operated at reduced flow rates. Determining, and hence accounting or compensating for, this additional transit time can help improve the accuracy of the analysis.

Particularly, knowledge of this transit time may be important during real-time or image guided analyses for providing an improved correlation between the ion analysis and the spatial position on the sample from which the analyte material was liberated. By compensating for the delay associated with the transit of the analyte material it is possible to map more precisely the results of the analysis to the corresponding location on the sample from which the analyte material was liberated. Knowledge of the transit time may also be useful for quality control or for providing feedback on the operation of the system. For instance, if the delay is changing significant there may be a problem within the sampling or transfer tube.

Accordingly, the techniques described herein provide improved methods of analysis.

By incorporating a device for detecting the presence of analyte material at a first position from which a determination of the transit time of the analyte material through the sampling or transfer tube can be made, it is possible for the temporal delay associated with the transit of analyte material through the sampling or transfer tube to be measured and compensated for in near real-time. That is, the transit time may be determined substantially in real time and/or during the course of an analysis/experimental run. The transit time may optionally be determined using a subsequent (downstream of the first position) detection of the analyte material. However, it may also be determined e.g. based on a known or expected transit time through the remainder of the sampling or transfer system downstream of the first position.

From another aspect there is provided a method of analysis comprising:

liberating analyte material from a sample;

transferring the analyte material towards an inlet via a sampling or transfer tube and transferring the analyte material through the inlet to an ion analyser and analysing the analyte material and/or ions derived from the analyte material at the ion analyser;

the method further comprising:

detecting the presence of the analyte material at a first position within or along the sampling or transfer tube.

It has also been recognised that it is advantageous in its own right to be able to detect the presence of analyte material at a first position within or along the sampling or transfer tube. Knowledge of the presence of analyte material at a certain position within the sampling or transfer tube may itself be useful for quality control or to provide feedback that may be useful for parameter optimisation or fault diagnostics. For instance, if analyte material is detected at a certain critical point (e.g. downstream of a junction, angle or bend within the sampling or transfer tube), this information may be used to provide feedback that the transfer system is working correctly, at least in transferring analyte material to that point. Similarly, by making a plurality of such detections along the length of the sampling or transfer tube the location of a fault may be determined and more readily diagnosed. Furthermore, a detection of analyte material at a certain point within the sampling or transfer tube may indicate that the step of liberating analyte material from the sample is being performed efficiently. For example, where a probe is used to liberate the analyte material, the subsequent detection of the analyte material in the sampling or transfer tube may indicate that the probe power is high enough and/or that there is sufficient contact with the sample.

Knowledge of the presence of analyte material at a certain position may also by itself be sufficient to determine or estimate a transit time through the sampling or transfer tube. For instance, knowledge of the presence of analyte material at a first point in combination with an expected transit time through the remainder of the system may be used to determine or estimate a transit time.

The first position may be generally somewhere between the sample and the inlet to the ion analyser. That is, the first position may be upstream of the inlet. Typically, the first position may be within the sampling or transfer tube. That is, the first position may be between the entrance to the sampling or transfer tube and the inlet.

Where the detection is used to determine a transit time in combination with a subsequent detection, the detection at the first position may occur at a first time T1, and the subsequent detection at a second time T2, with the transit time between the first position and the position at which the subsequent detection is made being determined as T2-T1.

It will be appreciated that the first position may comprise an extended region along the sampling or transfer tube such that the presence of analyte material is detected throughout this region. In this way, the transit time through this region may be determined directly from this detection i.e. the detection at the first position.

The sampling or transfer tube may but need not be a single or continuous length of tube. For instance, the sampling or transfer tube may comprise an extended or multi-part sampling or transfer tube system. A person skilled in the art will understand that a determination may be made for the transit time of analyte material through any part or all of the sampling or transfer tube provided that appropriate means for detecting the presence of the analyte material are provided. Generally, the sampling or transfer tube may comprise the entire length of the region between the sample (i.e. or the entrance to the sampling or transfer tube) and the inlet through which the analyte material is transferred. It will be appreciated that the sampling or transfer tube may also therefore contain other components such as pumping devices, ionisation devices or collision surfaces that act to break up or fragment the initial liberated analyte material into smaller clusters or components.

Generally, the method may comprise a number of discrete events of liberating analyte material from a sample during the course of a single experimental cycle, for example from multiple different locations on the sample, or from multiple different samples. That is, the method may comprise liberating the analyte material in a pulsed manner and/or as a series of discrete events. The method may then comprise determining the transit time for the liberated analyte for each of these discrete events. However, it is also contemplated that analyte may be liberated in a substantially continuous manner.

In any or all of the techniques described herein the sample may be open to atmospheric or ambient pressure. The method may comprise contacting the sample to liberate the analyte material at atmospheric or ambient pressure.

The inlet may separate regions of different pressures. For example, the inlet may comprise or differential pumping aperture which leads to a reduced pressure or vacuum region. The sampling or transfer tube may be held at or pumped to an intermediate pressure between the sample and the ion analyser. The sampling or transfer tube may bridge between different pressure regions at the sample and the ion analyser. A pumping device may be provided for controlling or adjusting the pressure or pressure gradient within the sampling or transfer tube. The analyte material may be aspirated or drawn into the sampling or transfer tube e.g. by a pressure gradient and/or by a pump.

It will be appreciated that the analyte material that is liberated from the sample may contain a mixture of neutrals and ions, and/or that it may break up or fragment into smaller components or ions during its transfer to the inlet (generally, upstream of the inlet). However, typically the analyte material may be ionised (or further ionised) downstream of the inlet to the ion analyser, e.g. by an ionisation source as is known in the art or by impacting upon a collision surface located within a vacuum chamber. Generally, the method may comprise a step of converting the analyte material into ions within said sampling or transfer tube and/or within an ionisation source region at or through said inlet.

Generally, the method may further comprise ionising at least some aerosol, smoke or vapour liberated from the sample so as to generate analyte ions. At least of the aerosol, smoke or vapour may be directed into a vacuum chamber of a mass spectrometer. At least some of the aerosol, smoke or vapour may be ionised within a or the vacuum chamber of the mass spectrometer so as to generate a plurality of analyte ions. The aerosol, smoke or vapour may be caused to impact upon a collision surface located within a vacuum chamber of the mass spectrometer so as to generate a plurality of analyte ions.

The analyte material or the ionised analyte material may also be processed after passing through the inlet e.g. it may be fragmented or reacted before arriving at the ion analyser. In this case it is the product ions derived from the precursor analyte ions that will be analysed by the ion analyser (and hence which may be used as the subsequent detection).

The method may generally relate to a method of ion analysis such as mass spectrometry and/or ion mobility. The method may comprise a method of interfacing a sample and a mass spectrometer.

The method may comprise a non-surgical, non-therapeutic or non-diagnostic method. The sample may comprise a non-living, non-human or non-animal sample. The sample may, for instance, comprise a pharmaceutical tablet or other pharmaceutical product, a food or meat product, a bacterial colony or a dead biological organism.

Liberating analyte material from the sample may comprise generating aerosol, smoke or vapour from the sample.

That is, the analyte material being transferred in the sampling or transfer tube may be gaseous or aerosolised. The step of liberating analyte material from the sample may comprise activating a source of power and/or contacting the sample with a suitable probe to vaporise or otherwise disintegrate part of the sample to form gaseous or aerosolised analyte particles. The aerosol, smoke or vapour may generally comprise uncharged aqueous droplets.

The step of activating a source of power and/or contacting the sample may define an initial trigger that is used in part to determine the transit time. For instance, the transit time may be determined using the detection at the first position occurring after the initial triggering event.

The sample may comprise native or unmodified tissue. By native or unmodified tissue it will be understood that no sample preparation is required and that analyte may be liberated directly from the tissue. For instance, native tissue is generally unmodified by the addition of a matrix or reagent. The sample may comprise biological tissue. The biological tissue may comprise either in vivo or ex vivo biological tissue. The first position may be at or near an entrance to the sampling or transfer tube.

Generally, the first position may be within the sampling or transfer tube. However, it is also contemplated that the first position may be outside of the sampling or transfer tube e.g. a detector may be mounted just outside the sampling or transfer tube, around the entrance or may itself define part of the entrance of the sampling or transfer tube. It will be appreciated that the entrance to the sampling or transfer tube is the end through which the analyte material enters the sampling or transfer tube, i.e. the end located closest to the sample. The other end of the sampling or transfer tube, i.e. the exit, is that which passes the analyte material through the inlet to the analyser.

Typically, the first position will be substantially adjacent to the entrance of the sampling or transfer tube. By having the first position close to the entrance of the sampling or transfer tube (and hence close to the sample), the determination may account for essentially the whole of the transit time between the sample and the subsequent detection. It will be appreciated that for reasons of safety or space the first position may have to slightly spaced-apart from the sample (i.e. the position of contact with the sample).

The subsequent detection may be performed by the ion analyser.

That is, the step of analysing the analyte material and/or the ions derived from the analyte material at the ion analyser may comprise the subsequent detection. For example, the subsequent detection may be the arrival time of the ions derived from the analyte material at a Time of Flight detector.

The subsequent detection may be at a second position within the sampling or transfer tube and/or at or near the inlet.

A second detection may be made at the end of the sampling or transfer tube just upstream of the inlet to the ion analyser.

The determination may be made using the detection at the first position, a detection at a second position within the sampling or transfer tube and/or at or near the inlet and a detection by the ion analyser.

That is, the determination may be made by a first detection at the first position, a second or further detection at a second position and a third or further detection at the ion analyser. Further detections of the analyte material may also be made at any other positions within the system as appropriate.

In embodiments, the presence of analyte material may be detected by measuring a change in resistance and/or impedance. That is, the presence of analyte material may be measured using a device (or circuitry) for measuring resistance and/or impedance. For instance, the presence of analyte material may be detected by measuring a change in resistance and/or impedance associated with the presence or passage of the analyte material. For example, when the analyte material passes through or by a position (e.g. the first and/or second position) where it is desired to detect the analyte material, the resistance or impedance measured at that position may drop since the analyte material may typically be more conductive than the air or gas that would otherwise be present in the sampling or transfer tube. In some embodiments, the device for measuring the resistance and/or impedance may comprise one or more conductive (e.g. metal) components, such as rings, disposed within the sampling or transfer tube that are connected (or connectable) to resistance and/or impedance measuring circuitry.

It is also contemplated that the presence of analyte material may be detected using a transmitter-receiver pair. For instance, the transmitter may comprise an LED and the receiver may comprise a photodiode. The transmitter and receiver may also comprise ultrasonic transducers.

The presence of analyte material may also be detected by measuring a change in capacitance. That is, the presence of analyte material may be detected using a capacitive sensor.

In general, detecting the presence of the analyte material may be performed by a detector. The detector used for detecting the presence of analyte material may be arranged so that there are no significant interactions with the analyte material i.e. so that the transit of the analyte material is substantially unaffected by the presence of the detector and so that the nature of the analyte material is not substantially changed by its detection. Optical sensors may be suitable in this respect. However, it will be appreciated that infrared or ultrasonic sensors may also suitably be used. Any other suitable means for detecting the presence of the analyte may be suitable used including, for instance, a device for detecting a temperature or pressure change due to the presence of the analyte material, or a flow sensor. The detector may generate a signal associated with the presence or transit of analyte material past or through the detector. This signal or data indicative of this signal may be provided as output for use in determining the transit time of the analyte material.

Detecting the presence of analyte material may simply constitute detecting whether and at what time material passes the detector. However, it is also envisaged that the detection may also comprise detecting, estimating or determining a quantity, density and/or composition of the analyte material. For example, for the case where an LED-photodiode pair is used as a detector, the size of the reduction in signal intensity and/or the length of time that a reduction in signal intensity is observed may be correlated with the amount/density of analyte material passing the detector.

Liberating analyte material from the sample may comprise liberating analyte material by an ambient ionisation process. Particularly, liberating analyte material from the sample may comprise liberating analyte material by a rapid evaporative ionisation process. For instance, the analyte material may be generated by direct evaporation or vaporisation of the sample e.g. by Joule heating or diathermy.

Particularly, the method may comprise a method of rapid evaporative ionisation mass spectrometry. The method may comprise contacting the sample with a probe to vaporise or otherwise disintegrate the sample material to form gas-phase or aerosol analyte material. The sampling or transfer tube may be provided as part of a device including the probe so that the entrance to the sampling or transfer tube is proximate to the point of contact between the probe and the sample. The device including the probe and/or the sampling or transfer tube may be handheld or portable. The device may for instance be robotically controlled and manoeuvred around the sample so as to liberate analyte from different parts of the sample and pass this via the sampling or transfer tube to the inlet and ion analyser. In other embodiments, the sampling or transfer tube and the probe may be provided as separate components so that they are independently movable relative to the sample.

The inlet and ion analyser may be any inlet compatible with ambient ionisation or rapid evaporative ionisation processes. Typically, the sampling or transfer tube and/or the inlet may be arranged to interface with atmospheric or ambient pressure.

Liberating analyte material from the sample may comprise contacting the sample with an ablation or coagulation device, a laser beam, an electrode, an ultrasonic probe, or a fluid jet.

Contacting a sample with an ablation or coagulation device, a high power laser beam, electrode, ultrasonic probe or fluid jet can vaporise or otherwise disintegrate the sample to liberate gas-phase or aerosol analyte material. That is, contacting the sample with an ablation or coagulation device, a laser beam, an electrode, an ultrasonic probe or a fluid jet may comprise a rapid evaporative ionisation process.

It will be appreciated that any suitable process, particularly any suitable ambient ionisation process, may be used to liberate analyte material and that the invention is not necessarily limited to rapid evaporative ionization mass spectrometry (“REIMS”) technology.

From another aspect there is provided a method of image guided analysis comprising a method substantially as described above, and further comprising:

liberating analyte material from different locations on the sample; and

mapping the analysed material to a corresponding location on the sample.

The analysed material is that which is analysed by the ion analyser. The step of analysing the analyte material and/or ions derived from the analyte material at the ion analyser may comprise generating one or more spectra (e.g. mass spectra) and the method may comprise correlating the spectra with the location on the sample from which the analyte material was liberated. The mapping or correlation may be based in part on the determination of the transit time. The location on the sample may be determined using a navigation system. For example, where the analyte material is liberated using a probe that is brought into contact with or focussed onto the sample, the navigation system may be used to control the spatial position of the probe relative to the sample.

From another aspect there is provided a method of mass spectrometry comprising a method substantially as described above.

In this case, the ion analyser comprises a mass analyser of a mass spectrometer and the inlet comprises the sampling inlet to the mass spectrometer. The method may generally comprise mass analysing analyte ions (which may be formed in any of the manners described above) in order to obtain mass spectrometric data.

From another aspect there is provided a system for analysis comprising:

a probe for liberating analyte material from a sample;

a transfer or sampling tube for transferring the liberated analyte material from the sample to an inlet;

an ion analyser situated downstream of the inlet for analysing the analyte material and/or ions derived from the analyte material; and

a device for detecting the presence of the analyte material at a first position and for determining the transit time of the analyte material through at least a part of the sampling or transfer tube using the detection at the first position and optionally a subsequent detection of the analyte material and/or of ions derived from the analyte material.

From yet another aspect there is provided a system for analysis comprising:

a probe for liberating analyte material from a sample;

a transfer or sampling tube for transferring the liberated analyte material from the sample to an inlet;

an ion analyser situated downstream of the inlet for analysing the analyte material and/or ions derived from the analyte material; and

a device for detecting the presence of the analyte material at a first position within or along the sampling or transfer tube.

The ion analyser may comprise a mass spectrometer. The ion analyser may comprise an ion mobility spectrometer.

The probe may comprise an ambient ionisation probe, particularly a rapid evaporative ionisation probe. A rapid evaporative ionisation probe is one that liberates analyte material from a sample by the process of rapid evaporative ionisation. The probe may vaporise or otherwise disintegrate the sample to form gas-phase or aerosol particles. For example, the ambient ionisation or rapid evaporative ionisation probe may comprise an ablation or coagulation device, a laser beam, an electrode, an ultrasonic probe, or a fluid jet. Naturally, where an ambient ionisation probe is used, the inlet is arranged to be compatible with the ambient ionisation process.

The system may further comprise a processor or processing means that receives a signal or data indicative of a signal from the means for detecting the presence of the analyte material indicating that analyte material is present and processes this signal and a signal associated with the subsequent detection to determine the transit time of the analyte material. The signal or data indicative of the signal from the means for detecting the presence of the analyte material may be provided as output e.g. may be displayed to a user. Alternatively, this information need not be displayed to a user and instead the result of the processing i.e. the determination or a correlation or calibration based on the determination only may be provided to the user. The processor or processing means may be the same processor or processing means used to process the signals generated at the ion analyser, and may be the same processor or processing means used to control a navigation system where one is employed. However, it is also contemplated that separate processors may be used.

The system may also include any or all of the features described above or may be arranged and adapted to perform any of the steps described above in relation to the previous aspects to the extent that they are not mutually incompatible.

From another aspect there is provided a sampling or transfer tube for interfacing with an inlet of an ion analysis instrument comprising a device for detecting the presence of analyte material at a first position within the sampling or transfer tube.

The device may provide a signal to a processor or processing means for use in determining the transit time of analyte material through at least a part of the sampling or transfer tube. Typically, the processor or processing means will not be provided as part of the sampling or transfer tube itself but will be external thereto. Accordingly, the sampling or transfer tube may further comprise connections for interfacing with external electronics, processor or processing means. The connections may, for example, be in the form of embedded conductors arranged to provide the output signal from the means for detecting the presence of analyte material to the (external) processor or processing means. As noted above, the external processor or processing means may be the processor or processing means associated with the ion analysis instrument, but may be some other processor or processing means.

The sampling or transfer tube may further comprise a second device for detecting the presence of analyte material at a second position within the sampling or transfer tube.

The device (and/or second device) for detecting the presence of analyte material may comprise a device for measuring resistance and/or impedance. The device (and/or second device) for detecting the presence of analyte material may comprise a transmitter-receiver pair. The transmitter may comprise an LED and the receiver may comprise a photodiode detector. The transmitter and receiver may comprise ultrasonic transducers. In embodiments, the device may detect a change in capacitance caused by the presence of analyte material. That is, the device (and/or second device) may comprise a capacitive sensor.

The means for detecting the presence of the analyte material may become dirty or clouded over in use as analyte material deposits on the walls of the sampling or transfer tube, particularly where an optical sensor is used, and may require cleaning and/or replacement during use. Accordingly, the device may be removable or replaceable.

From another aspect there is provided an endoscope comprising a sampling or transfer tube substantially as described above and arranged to be interfaced with an ion analysis instrument such as a mass spectrometer.

In use, analyte material liberated from a sample when contacted by an endoscopic snare and applying RF power to the snare may be received by the sampling or transfer tube and transferred to the ion analysis instrument. That is, the sampling or transfer tube is arranged relative to the endoscopic snare such that analyte material generated from the sample may be received, drawn up or aspirated into the sampling or transfer tube for transfer to the ion analysis instrument. The sampling or transfer tube may be arranged to be interfaced with an ion analysis instrument such that analyte material generated through use of the endoscope may be transferred to the ion analysis instrument through the sampling or transfer tube.

From another aspect there is provided an electrosurgical or diathermy knife comprising a sampling or transfer tube substantially as described above and arranged to be interfaced with an ion analysis instrument such as a mass spectrometer.

In use, analyte material liberated from a sample when contacted by an electrode of the electrosurgical knife may be received by the sampling or transfer tube and transferred to the ion analysis instrument. That is, the sampling or transfer tube is arranged relative to the electrode such that analyte material generated by the electrosurgical or diathermy knife may be received, drawn up or aspirated into the sampling or transfer tube for transfer to the ion analysis instrument. The sampling or transfer tube is arranged to be interfaced with an ion analysis instrument such that analyte material generated through use of the electrosurgical or diathermy knife may be transferred to the ion analysis instrument through the sampling or transfer tube.

From another aspect there is provided a laser probe comprising a sampling or transfer tube substantially as described above and arranged to be interfaced with an ion analysis instrument such as a mass spectrometer.

In use, analyte material liberated from a sample when contacted by the laser beam of the probe may be received by the sampling or transfer tube and transferred to the ion analysis instrument. That is, the sampling or transfer tube is arranged relative to the laser beam such that analyte material generated by the laser probe may be received, drawn up or aspirated into the sampling or transfer tube for transfer to the ion analysis instrument.

The sampling or transfer tube may be arranged to be interfaced with an ion analysis instrument such that analyte material generated through use of the laser beam may be transferred to the ion analysis instrument through the sampling or transfer tube.

The sampling or transfer tube, the endoscope, the electrosurgical or diathermy knife and/or the laser probe of any of these aspects may be used in or with the system(s) as described above herein. That is the probe, or more particularly the rapid evaporative ionisation probe, of the system described above may comprise an endoscopic snare, an electrosurgical or diathermy knife and/or a laser probe.

The ion analyser or system described in relation to any of the aspects or embodiments above may generally comprise a spectrometer, such as a mass and/or ion mobility spectrometer.

### BRIEF DESCRIPTION OF THE DRAWINGS

Various embodiments will now be described, by way of example only, and with reference to the accompanying drawings in which:

FIG. 1 illustrates the general principles of rapid evaporative ionisation mass spectrometry (“REIMS”) technology;

FIG. 2A shows a modified monopolar handpiece including an aerosol detector for use with the techniques described herein and FIG. 2B shows the location of a second aerosol detector near the inlet to a mass spectrometer;

FIGS. 3A-D illustrate how the transit time of analyte material may be determined from a series of defined events including the monopolar device being energised (FIG. 3A), aerosol triggering a first aerosol detector within the sampling or transfer tube (FIG. 3B), aerosol triggering a second aerosol detector as the mass spectrometer inlet (FIG. 3C) and the eventual detection of ions derived from the aerosol at the mass spectrometer detector (FIG. 3D shows a total ion current chromatogram recorded at the detector);

FIG. 4 shows the timing cycles associated with the events shown in FIGS. 3A-D;

FIG. 5 shows a modified laser probe including an aerosol detector for use with the techniques described herein; and

FIG. 6 shows a modified endoscope probe including an aerosol detector for use with the techniques described herein.

### DETAILED DESCRIPTION

Various embodiments as will be described in more detail below are concerned with a method of rapid evaporative ionization mass spectrometry (“REIMS”) analysis wherein an analyte material is liberated from a sample. The analyte material is then transferred towards an inlet of a mass spectrometer via a sampling or transfer tube. The analyte material may then be ionised by causing the analyte material to impact upon a collision surface located within a vacuum chamber of a mass spectrometer. The resulting analyte ions are then mass analysed and a transit time of the analyte material through at least a part of the sampling or transfer tube is determined.

It has been recognised that the transit time of analyte material through a sampling or transfer tube positioned between a sample and the inlet to an ion analyser may be significant, particularly where for reasons of safety or space the ion analyser is situated remotely from the sample being analysed so that a relatively extended sampling or transfer tubing is required or where the sampling or transfer tube is operated at reduced flow rates. Determining, and hence accounting or compensating for, this additional transit time can help improve the accuracy of the analysis.

Knowledge of this transit time may be important during real-time or image guided analyses for providing an improved correlation between the ion analysis and the spatial position on the sample from which the analyte material was liberated. By compensating for the delay associated with the transit of the analyte material it is possible to more precisely map the results of the analysis to the corresponding location on the sample from which the analyte material was liberated. Knowledge of the transit time may also be useful for quality control or for providing feedback on the operation of the system. For instance, if the delay is changing significant there may be a problem within the sampling or transfer tube.

Accordingly, the techniques described herein provide improved methods of analysis.

By incorporating a means for detecting the presence of analyte material at a first position from which a determination of the transit time of the analyte material through the sampling or transfer tube can be made, it is possible for the temporal delay associated with the transit of analyte material through the sampling or transfer tube to be measured and compensated for in near real-time. That is, the transit time may be determined substantially in real time and/or during the course of an analysis/experimental run. The first position may be generally somewhere between the sample and the inlet to the ion analyser. That is, the first position may be upstream of the inlet. Typically, the first position may be within the sampling or transfer tube. The detection at the first position may occur at a first time T1, and the subsequent detection at a second time T2, with the transit time between the first position and the position at which the subsequent detection is made being determined as T2-T1.

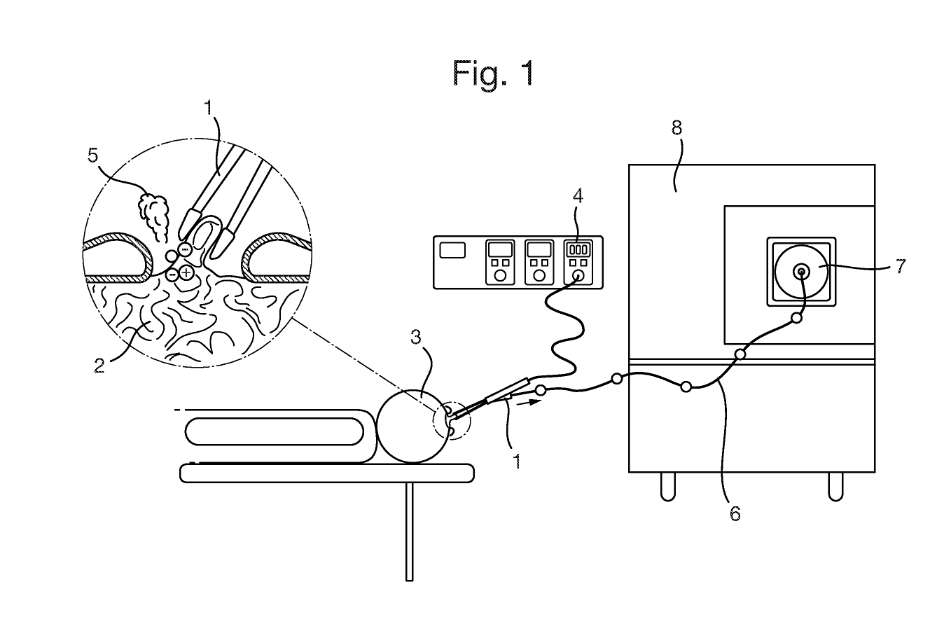

FIG. 1 illustrates a method of rapid evaporative ionisation mass spectrometry (“REIMS”) wherein bipolar forceps 1 may be brought into contact with in vivo tissue 2 of a patient 3. In the example shown in FIG. 1, the bipolar forceps 1 may be brought into contact with brain tissue 2 of a patient 3 during the course of a surgical operation on the patient's brain. An RF voltage from an RF voltage generator 4 may be applied to the bipolar forceps 1 which causes localised Joule or diathermy heating of the tissue 2. As a result, an aerosol or surgical plume 5 is generated. The aerosol or surgical plume 5 may then be captured or otherwise aspirated through an irrigation port of the bipolar forceps 1. The irrigation port of the bipolar forceps 1 is therefore reutilised as an aspiration port. The aerosol or surgical plume 5 may then be passed from the irrigation (aspiration) port of the bipolar forceps 1 to tubing 6 (e.g. ⅛″ or 3.2 mm diameter Teflon® tubing). The tubing 6 is arranged to transfer the aerosol or surgical plume 5 to an atmospheric pressure interface 7 of a mass spectrometer 8.

According to various embodiments a matrix comprising an organic solvent such as isopropanol may be added to the aerosol or surgical plume 5 at the atmospheric pressure interface 7. The mixture of aerosol 3 and organic solvent may then be arranged to impact upon a collision surface within a vacuum chamber of the mass spectrometer 8. According to one embodiment the collision surface may be heated. The aerosol is caused to ionise upon impacting the collision surface resulting in the generation of analyte ions. The ionisation efficiency of generating the analyte ions may be improved by the addition of the organic solvent. However, the addition of an organic solvent is not essential.

Analyte ions which are generated by causing the aerosol, smoke or vapour 5 to impact upon the collision surface are then passed through subsequent stages of the mass spectrometer and are subjected to mass analysis in a mass analyser. The mass analyser may, for example, comprise a quadrupole mass analyser or a Time of Flight mass analyser.

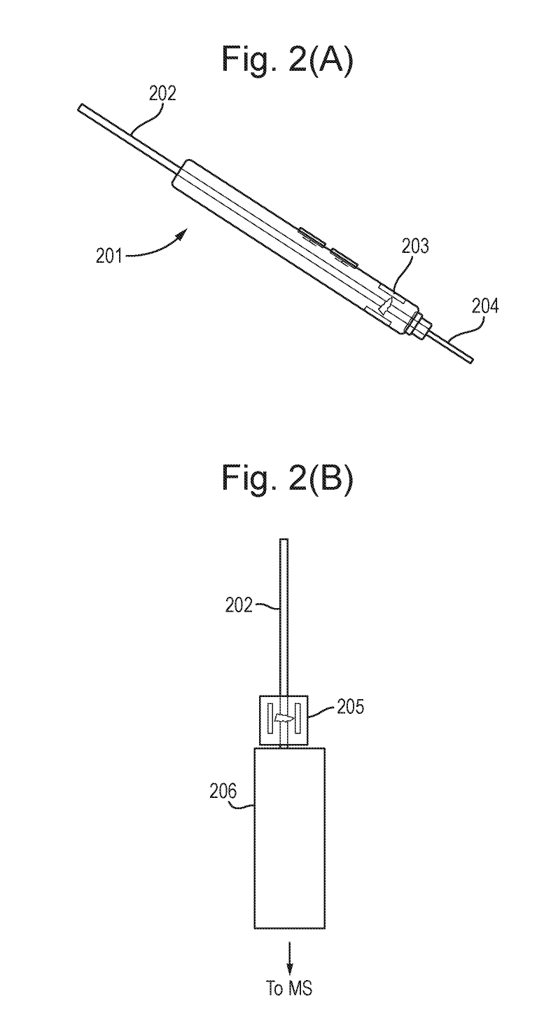

FIG. 2 shows a rapid evaporative ionization mass spectrometry (“REIMS”) compatible monopolar handpiece 201 or electrosurgical/diathermy knife of the type generally described in WO 2010/136887 (Takats) or WO 2012/164312 (Micromass) which is modified for use with the techniques described herein.

The handpiece 201 generally includes an electrode 204 to which electric power may be supplied and then transmitted to a sample contacted by the electrode 4. Contacting a sample with the electrode 204 may thus cut and vaporise or otherwise disintegrate the sample so as to generate gaseous or aerosolised particles of sample material. A sampling or transfer tube 202 is provided with the entrance to the sampling or transfer tube 202 being proximate to the electrode 204 such that the material liberated from the sample is received by the sampling or transfer tube 202 and transferred towards sampling inlet 206 of a mass spectrometer. The sample material may be drawn through the sampling or transfer tube 202 by a pressure differential or a pumping system or any other suitable means.

The process of contacting the sample with the electrode 204 may itself generate ions which may be directly analysed in the mass spectrometer, but ions may additionally or alternatively be formed via collisions within the sampling or transfer tube 202 and/or with other elements in the transfer system or at the inlet 206 of the mass spectrometer. Generally, an ionisation source may be provided within the mass spectrometer or the sample may be ionised by colliding with a collision surface located within a vacuum chamber of a mass spectrometer. In any case, at some point prior to its arrival at the ion analyser, the analyte material liberated from the sample is converted (where necessary) into ions for the mass analysis.

As described in WO 2010/136887 (Takats) and WO 2012/164312 (Micromass), the monopolar handpiece 201 may be used in a variety of applications for rapid or real-time analysis of atmospheric pressure samples.

However, for many rapid evaporative ionization mass spectrometry (“REIMS”) applications, the mass spectrometer may be sited remotely from the sample e.g. for reasons of safety or space. For example, where the handpiece 201 is being used in a surgical environment (e.g. incorporated into a surgical robot such as Da Vinci®) it is generally desirable for the mass spectrometer and associated electronics to be positioned outside of the operating theatre remote from the site of surgical intervention.

Where the mass spectrometer is sited remotely from the sample, or where the sampling or transfer system is operated at reduced flow rates (e.g. for laparoscopic devices) the time taken for the gas or aerosol produced from the sample to pass through the sampling or transfer tube 202 and reach the mass spectrometer can be significant.

Knowledge of this delay may be important where the handpiece 201 is being used in an image guided manner, for instance, in conjunction with a surgical (or bacterial) navigation system, or more generally where the handpiece 201 is used to analyse different locations on the sample, in order that the chemical or other information determined via the mass analysis can be mapped to the location that the data was gathered from. Knowledge of this delay may also be useful for quality control purposes or for providing feedback on the operation of the device. For example, if the delay is changing significantly this may be indicative of a problem somewhere in the sampling or transfer tube 202, or indeed with the handpiece 201 or electrode 204.

Accordingly, the monopolar handpiece 201 may be modified to include an aerosol (or smoke) detector 203 adjacent to the entrance of the sampling or transfer tube 202 in order to determine the transit time of the material through the sampling or transfer tube 202. A second aerosol (or smoke) detector 205 may be provided at the end of the sampling or transfer tube 202 adjacent to the inlet 206 of the mass spectrometer (although this is not essential). In the illustrated embodiment the aerosol detectors 203, 205 are each in the form of an LED-photodiode detector, where the presence of aerosol or gas is detected as a drop or reduction in intensity of the current measured at the photodiode as the aerosol or gas scatters the light from the LED. Generally however, any suitable detector may be used that detects the presence of the aerosol or gas without significantly interacting with, depleting or changing the nature of the aerosol or gas. Optical sensors may be particularly suitable for this purpose. However it will be appreciated that any other suitable sensor for detecting the presence of the gas or aerosol may be used. For instance, the sensor may comprise an IR or ultrasonic transducer transmitter-receiver pair. It is also contemplated that the sensor may be arranged to sense a change in resistance/impedance, capacitance, temperature or pressure caused by the passage of the analyte material. The sensor may even comprise a mechanical sensor e.g. an impeller-type flow sensor. For example, one suitable sensor arrangement for sensing a change in resistance/impedance may comprise one or more conductive (e.g. metal) components, such as rings, disposed within the sampling or transfer tube, with the conductive components connected in use to resistance/impedance measuring circuitry.

It is recognised that over time the aerosol may deposit on the walls of the sampling or transfer tubing and it may be necessary to calibrate or compensate the detector to account for this. For example, for the LED-photodiode detector described above the current baseline could be measured prior to each experimental run and/or prior to each step of liberating analyte material from the sample (i.e. prior to Event #1 as described below) and a detection would be made by a drop in current relative to this measured baseline. Alternatively/additionally, should the base current drop below a certain threshold, or after a certain amount of time (or number of uses), the detector may need to be cleaned or replaced. The detector may be made modular to facilitate cleaning or replacement. An alarm may be generated to indicate that the detector needs cleaning or replacing, i.e. in response to the base current dropping below a certain threshold.

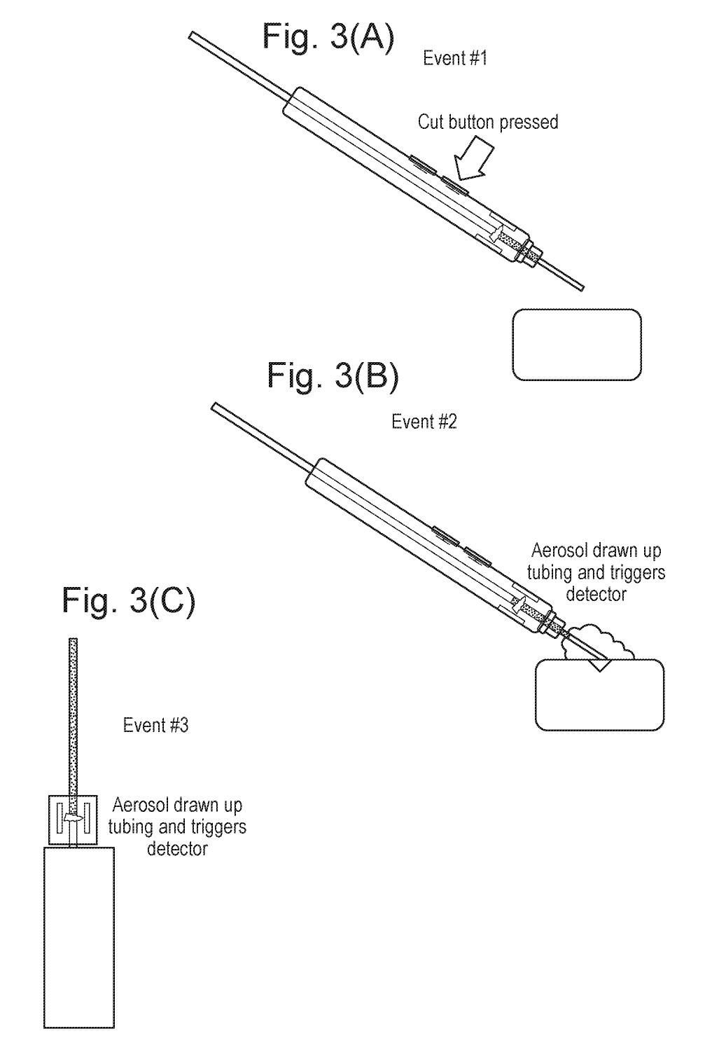

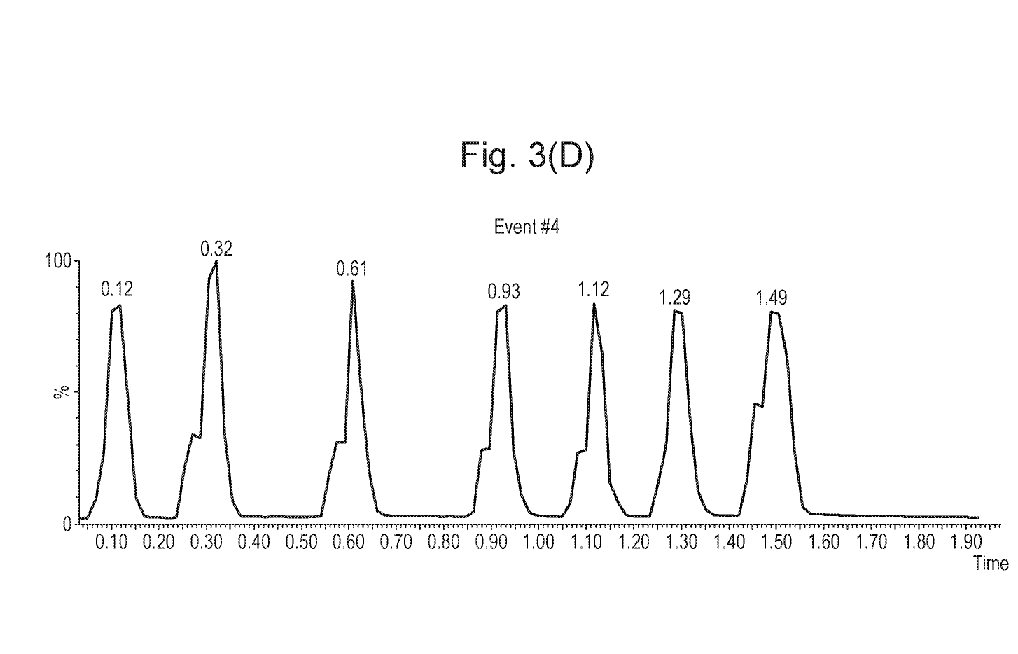

The detection(s) of the analyte material by the detectors 203, 205 defines in part a series of events that may be used to determine the transit time of the analyte material from the sample through the transfer or sampling tube 202 to the mass analyser. A typical series of events from which the transit time may be determined will now be described with reference to FIGS. 3 and 4.

As shown in FIG. 3A, the first event (Event #1) corresponds to the monopolar device being energised i.e. by pressing the ‘cut’ button to energise the RF power supply to the electrode 204 as or just prior to the electrode 204 being brought into contact with the sample. Contacting and cutting the sample with the electrode 204 ablates the sample tissue to generate aerosol/smoke. The aerosolised sample being drawn into the sampling or transfer tube 202 and triggering the first aerosol detector 203 defines a second event (Event #2) as shown in FIG. 3B. A third event (Event #3), as shown in FIG. 3C, may be the aerosol triggering the (optional) second aerosol detector 205 at the inlet 206 of the mass spectrometer at the rapid evaporative ionization mass spectrometry (“REIMS”) source. The final event (Event #4) may comprise the eventual detection of the signal associated with the analyte ions at the mass analyser of the mass spectrometer. For example, for a Time of Flight mass analyser, Event #4 may be triggered by an increase in the total ion current at the Time of Flight detector. FIG. 3D illustrates a total ion current chromatogram produced by the mass analyser from the ionisation and detection of the aerosol/smoke from a series of discrete events.

The transit time Δt of the analyte material may be calculated from the time (Δt) between the start of Events #2 and #4 as shown in FIG. 4. Naturally, it is possible to use other events or other detectors to define further events which may also be used to determine the or a transit time through part of the system between the sample and the ion analyser, and it will be understood that the sequence illustrated in FIGS. 3A-D and FIG. 4 is merely illustrative. For instance, it may be possible to determine a transit time based on detection within a single region or at a single position in combination with an expected transit time throughout the remainder of the sampling or transfer tube 202 and/or any components downstream of the inlet.

Once a determination of the transit time has been made this can then be used e.g. as discussed above to more accurately correlate the mass spectra recorded by the mass analyser with the position of the handpiece 201 relative to the sample e.g. as given by a navigation system used to control or manipulate the handpiece 201.

Although the example above has been described in the context of a monopolar handpiece (i.e. an electrosurgical or diathermy knife), it will be appreciated that the techniques described herein can also be extended to any other ambient ionisation-type techniques e.g. where aerosol or gas-phase analyte material is generated using a laser probe, ultrasonic probe or jet of fluid. Other suitable ambient ionisation sources are presented below.

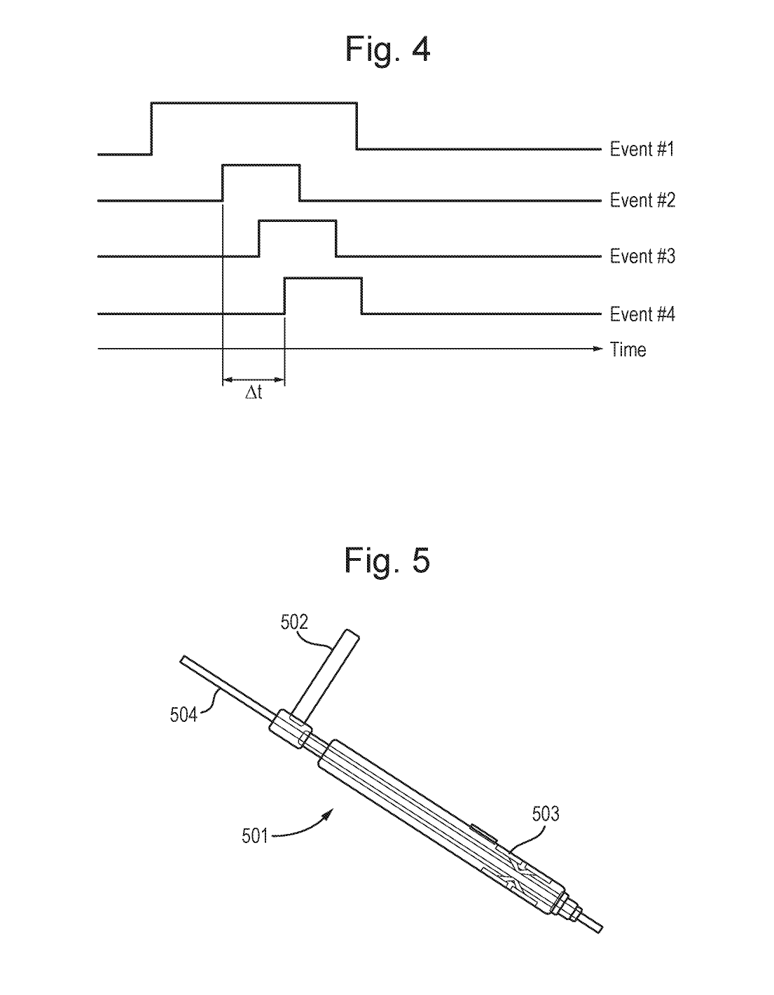

For instance, FIG. 5 shows a rapid evaporative ionization mass spectrometry (“REIMS”) compatible laser surgery probe 501 modified for use with the techniques described herein. In use, the laser probe 501 is directed onto a sample in order to cut and vaporise the sample and generate gaseous or aerosolised analyte material. The probe 501 therefore includes a fibre optic channel 504 for directing a laser beam onto a sample surface (not shown). Similar to the monopolar handpiece illustrated in FIG. 2, the probe 501 also includes a sampling or transfer tubing 502 for receiving aerosolised or gaseous analyte material liberated from the sample and for transferring the aerosolised or gaseous analyte material to the mass spectrometer. Again, an aerosol detection device 503 may be positioned adjacent the entrance to the sampling or transfer tubing 502 for use in determining the transit time of the analyte material through the sampling or transfer tubing 502.

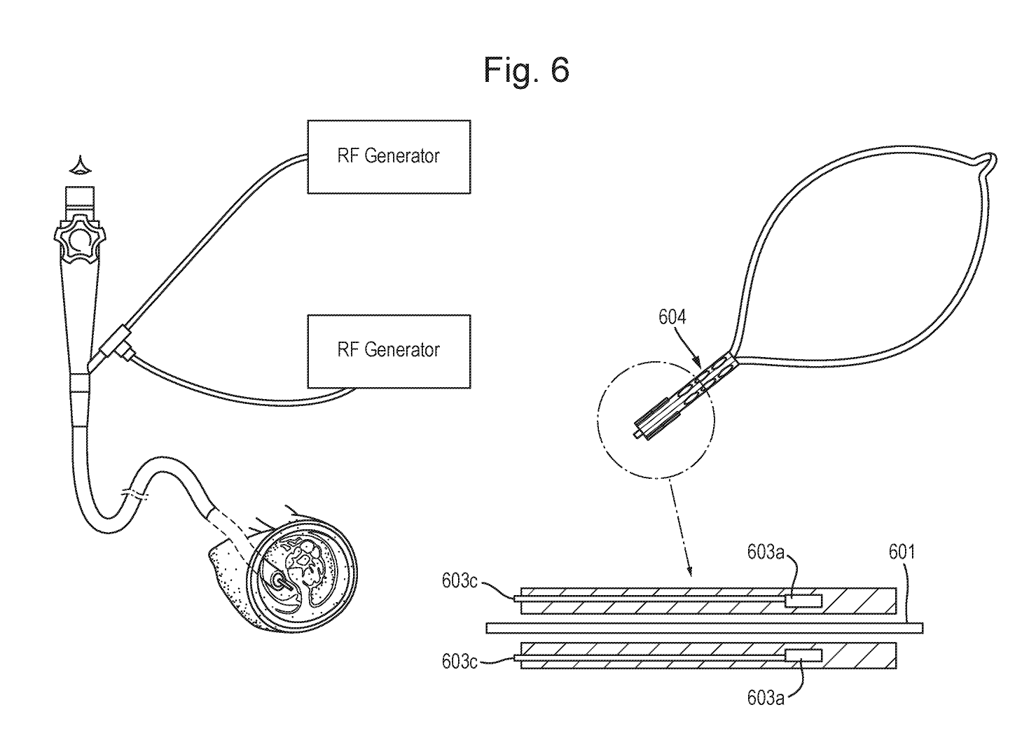

FIG. 6 illustrates a rapid evaporative ionization mass spectrometry (“REIMS”) compatible endoscopic probe which has been modified for use with the techniques described herein. RF power may be supplied to the endoscopic snare 601 to cut tissue held within the snare 601 with surgical smoke or aerosolised tissue being generated through vaporisation of the tissue. The endoscopic snare 601 may be adapted for the extraction of this surgical smoke or aerosolised tissue through the provision of fenestrations 604 in the sampling tubing close to the opening through which the snare 601 protrudes. The fenestrations 604 act as aspiration ports for drawing the gaseous or aerosolised analyte into a sampling or transfer tube which may be interfaced with an inlet to a mass spectrometer.

As in the previously described embodiments, a detector in the form of one or more transmitter-receiver pairs 603a-603b may be provided near the active end of the snare for detecting the presence of the smoke or aerosol. The detector should be arranged so as to not materially affect the performance of the endoscopic snare 601. For example, the detector may comprise an LED transmitter 603a and a photodiode receiver 603b. LED photodiode detectors may be fabricated to relatively small dimensions (for instance around 1 to 2 mm³ in volume) and may be interconnected using embedded conductors (603c) in such a manner that the performance of the endoscopic snare 601 is not detrimentally affected. In other embodiments, the detector may comprise one or more devices for sensing a change in resistance/impedance, capacitance, temperature or pressure caused by the passage of the analyte material, or a mechanical sensor e.g. an impeller-type flow sensor.

The techniques described herein may also be applied to the aerosol sampling system of a laparoscopic or robotic probe. In general, the techniques described herein may be applied to any system involving transferring analyte material from a sample through a relatively extended sampling or transfer tubing system where it is desired to be able to compensate for the delay associated with the transit of the analyte material through the sampling or transfer system.

It will also be appreciated that the techniques described herein are not limited to rapid evaporative ionization mass spectrometry (“REIMS”)-type probes and may be extended to other ionisation methods such as matrix-assisted laser desorption ionisation (“MALDI”) or laser description ionisation (“LDI”). Indeed, it will be appreciated that the techniques described herein may find general utility in any circumstances where it is desired to determine the transit time of some analyte material through a sampling or transfer tube interface between a sample and an ion analysis instrument. In particular, the techniques described herein may be suitable for any ambient ionisation process, or with any ambient ionisation ion source such as those described below.

### Ambient Ionisation Ion Sources

According to various embodiments a device is used to generate an aerosol, smoke or vapour from one or more regions of a target (e.g. in vivo tissue). The device may comprise an ambient ionisation ion source which is characterised by the ability to generate analyte aerosol, smoke or vapour from a native or unmodified target. For example, other types of ionisation ion sources such as Matrix Assisted Laser Desorption Ionisation (“MALDI”) ion sources require a matrix or reagent to be added to the sample prior to ionisation.

It will be apparent that the requirement to add a matrix or a reagent to a sample prevents the ability to perform in vivo analysis of tissue and also, more generally, prevents the ability to provide a rapid simple analysis of target material.

In contrast, therefore, ambient ionisation techniques are particularly advantageous since firstly they do not require the addition of a matrix or a reagent (and hence are suitable for the analysis of in vivo tissue) and since secondly they enable a rapid simple analysis of target material to be performed.

A number of different ambient ionisation techniques are known and are intended to fall within the scope of the present invention. As a matter of historical record, Desorption Electrospray Ionisation (“DESI”) was the first ambient ionisation technique to be developed and was disclosed in 2004. Since 2004, a number of other ambient ionisation techniques have been developed. These ambient ionisation techniques differ in their precise ionisation method but they share the same general capability of generating gas-phase ions directly from native (i.e. untreated or unmodified) samples. A particular advantage of the various ambient ionisation techniques which are intended to fall within the scope of the present invention is that the various ambient ionisation techniques do not require any prior sample preparation. As a result, the various ambient ionisation techniques enable both in vivo tissue and ex vivo tissue samples to be analysed without necessitating the time and expense of adding a matrix or reagent to the tissue sample or other target material.

A list of ambient ionisation techniques which are intended to fall within the scope of the present invention are given in the following table:

| Acronym | Ionisation technique |
|---|---|
| DESI | Desorption electrospray ionization |
| DeSSI | Desorption sonic spray ionization |
| DAPPI | Desorption atmospheric pressure |
| | photoionization |
| EASI | Easy ambient sonic-spray ionization |
| JeDI | Jet desorption electrospray ionization |
| TM-DESI | Transmission mode desorption electrospray |
| | ionization |
| LMJ-SSP | Liquid microjunction-surface sampling probe |
| DICE | Desorption ionization by charge exchange |
| Nano-DESI | Nanospray desorption electrospray ionization |
| EADESI | Electrode-assisted desorption electrospray |
| | ionization |
| APTDCI | Atmospheric pressure thermal desorption |
| | chemical ionization |
| V-EASI | Venturi easy ambient sonic-spray ionization |
| AFAI | Air flow-assisted ionization |
| LESA | Liquid extraction surface analysis |
| PTC-ESI | Pipette tip column electrospray ionization |
| AFADESI | Air flow-assisted desorption electrospray |
| | ionization |
| DEFFI | Desorption electro-flow focusing ionization |
| ESTASI | Electrostatic spray ionization |
| PASIT | Plasma-based ambient sampling ionization |
| | transmission |
| DAPCI | Desorption atmospheric pressure chemical |
| | ionization |
| DART | Direct analysis in real time |
| ASAP | Atmospheric pressure solid analysis probe |
| APTDI | Atmospheric pressure thermal desorption |
| | ionization |
| PADI | Plasma assisted desorption ionization |
| DBDI | Dielectric barrier discharge ionization |
| FAPA | Flowing atmospheric pressure afterglow |
| HAPGDI | Helium atmospheric pressure glow discharge |
| | ionization |
| APGDDI | Atmospheric pressure glow discharge |
| | desorption ionization |
| LTP | Low temperature plasma |
| LS-APGD | Liquid sampling-atmospheric pressure glow |
| | discharge |
| MIPDI | Microwave induced plasma desorption |
| | ionization |
| MFGDP | Microfabricated glow discharge plasma |
| RoPPI | Robotic plasma probe ionization |
| PLASI | Plasma spray ionization |
| MALDESI | Matrix assisted laser desorption electrospray |
| | ionization |
| ELDI | Electrospray laser desorption ionization |
| LDTD | Laser diode thermal desorption |
| LAESI | Laser ablation electrospray ionization |
| CALDI | Charge assisted laser desorption ionization |
| LA-FAPA | Laser ablation flowing atmospheric pressure |
| | afterglow |
| LADESI | Laser assisted desorption electrospray |
| | ionization |
| LDESI | Laser desorption electrospray ionization |
| LEMS | Laser electrospray mass spectrometry |
| LSI | Laser spray ionization |
| IR-LAMICI | Infrared laser ablation metastable induced |
| | chemical ionization |
| LDSPI | Laser desorption spray post-ionization |
| PAMLDI | Plasma assisted multiwavelength laser |
| | desorption ionization |
| HALDI | High voltage-assisted laser desorption |
| | ionization |
| PALDI | Plasma assisted laser desorption ionization |
| ESSI | Extractive electrospray ionization |
| PESI | Probe electrospray ionization |
| ND-ESSI | Neutral desorption extractive electrospray |
| | ionization |
| PS | Paper spray |
| DIP-APCI | Direct inlet probe-atmospheric pressure |
| | chemical ionization |
| TS | Touch spray |
| Wooden-tip | Wooden-tip electrospray |
| CBS-SPME | Coated blade spray solid phase |
| | microextraction |
| TSI | Tissue spray ionization |
| RADIO | Radiofrequency acoustic desorption ionization |
| LIAD-ESI | Laser induced acoustic desorption |
| | electrospray ionization |
| SAWN | Surface acoustic wave nebulization |
| UASI | Ultrasonication-assisted spray ionization |
| SPA-nanoESI | Solid probe assisted nanoelectrospray |
| | ionization |
| PAUSI | Paper assisted ultrasonic spray ionization |
| DPESI | Direct probe electrospray ionization |
| ESA-Py | Electrospray assisted pyrolysis ionization |
| APPIS | Ambient pressure pyroelectric ion source |
| RASTIR | Remote analyte sampling transport and |
| | ionization relay |
| SACI | Surface activated chemical ionization |
| DEMI | Desorption electrospray metastable-induced |
| | ionization |
| REIMS | Rapid evaporative ionization mass |
| | spectrometry |
| SPAM | Single particle aerosol mass spectrometry |
| TDAMS | Thermal desorption-based ambient mass |
| | spectrometry |
| MAII | Matrix assisted inlet ionization |
| SAII | Solvent assisted inlet ionization |
| SwiFERR | Switched ferroelectric plasma ionizer |
| LPTD | Leidenfrost phenomenon assisted thermal |
| | desorption |

According to an embodiment the ambient ionisation ion source may comprise a rapid evaporative ionisation mass spectrometry (“REIMS”) ion source wherein a RF voltage is applied to one or more electrodes in order to generate an aerosol or plume of surgical smoke by Joule heating.

However, it will be appreciated that other ambient ion sources including those referred to above may also be utilised. For example, according to another embodiment the ambient ionisation ion source may comprise a laser ionisation ion source. According to an embodiment the laser ionisation ion source may comprise a mid-IR laser ablation ion source. For example, there are several lasers which emit radiation close to or at 2.94 μm which corresponds with the peak in the water absorption spectrum. According to various embodiments the ambient ionisation ion source may comprise a laser ablation ion source having a wavelength close to 2.94 μm on the basis of the high absorption coefficient of water at 2.94 μm. According to an embodiment the laser ablation ion source may comprise a Er:YAG laser which emits radiation at 2.94 μm.

Other embodiments are contemplated wherein a mid-infrared optical parametric oscillator (“OPO”) may be used to produce a laser ablation ion source having a longer wavelength than 2.94 μm. For example, an Er:YAG pumped ZGP-OPO may be used to produce laser radiation having a wavelength of e.g. 6.1 μm, 6.45 μm or 6.73 μm. In some situations it may be advantageous to use a laser ablation ion source having a shorter or longer wavelength than 2.94 μm since only the surface layers will be ablated and less thermal damage may result. According to an embodiment a Co:MgF₂ laser may be used as a laser ablation ion source wherein the laser may be tuned from 1.75-2.5 μm. According to another embodiment an optical parametric oscillator (“OPO”) system pumped by a Nd:YAG laser may be used to produce a laser ablation ion source having a wavelength between 2.9-3.1 μm. According to another embodiment a CO₂ laser having a wavelength of 10.6 μm may be used to generate the aerosol, smoke or vapour.

According to other embodiments the ambient ionisation ion source may comprise an ultrasonic ablation ion source which generates a liquid sample which is then aspirated as an aerosol. The ultrasonic ablation ion source may comprise a focused or unfocussed source.

According to an embodiment the first device for generating aerosol, smoke or vapour from one or more regions of a target may comprise an electrosurgical tool which utilises a continuous RF waveform. According to other embodiments a radiofrequency tissue dissection system may be used which is arranged to supply pulsed plasma RF energy to a tool. The tool may comprise, for example, a PlasmaBlade®. Pulsed plasma RF tools operate at lower temperatures than conventional electrosurgical tools (e.g. 40-170° C. c.f. 200-350° C.) thereby reducing thermal injury depth. Pulsed waveforms and duty cycles may be used for both cut and coagulation modes of operation by inducing electrical plasma along the cutting edge(s) of a thin insulated electrode.

### Methods of Medical Treatment, Surgery and Diagnosis and Non-Medical Methods

Various different embodiments are contemplated. According to some embodiments the methods disclosed above may be performed on in vivo, ex vivo or in vitro tissue. The tissue may comprise human or non-human animal tissue.

Various surgical, therapeutic, medical treatment and diagnostic methods are contemplated.

However, other embodiments are contemplated which relate to non-surgical and non-therapeutic methods of mass spectrometry which are not performed on in vivo tissue.

Other related embodiments are contemplated which are performed in an extracorporeal manner such that they are performed outside of the human or animal body.

Further embodiments are contemplated wherein the methods are performed on a non-living human or animal, for example, as part of an autopsy procedure.

Although the present invention has been described with reference to various embodiments, it will be understood by those skilled in the art that various changes in form and detail may be made without departing from the scope of the invention as set forth in the accompanying claims.

1. A method of analysis comprising:
liberating analyte material from a sample;
transferring said analyte material towards an inlet via a sampling or transfer tube and transferring said analyte material through said inlet to an ion analyser;
detecting the presence of said analyte material at a first position; and
analysing said analyte material and/or ions derived from said analyte material at said ion analyser;
the method further comprising:
determining a transit time of said analyte material through at least a part of said sampling or transfer tube using said detection at said first position.

2. A method as claimed in wherein the presence of said analyte material is detected at said first position within said sampling or transfer tube.

3. A method as claimed in claim 1, wherein the step of liberating analyte material from the sample comprises generating aerosol, smoke or vapour from the sample.

4. (canceled)

5. A method as claimed in claim 1, wherein said first position is at or near an entrance to said sampling or transfer tube.

6. A method as claimed in claim 1, wherein the transit time of said analyte material through the at least a part of said sampling or transfer tube is determined using said detection at said first position and a subsequent detection of said analyte material and/or of ions derived from said analyte material, wherein said or a subsequent detection is performed by or at the ion analyser.

7. A method as claimed in claim 1, wherein the transit time of said analyte material through the at least a part of said sampling or transfer tube is determined using said detection at said first position and a subsequent detection of said analyte material and/or of ions derived from said analyte material, wherein said or a subsequent detection is at a second position within said sampling or transfer tube and/or at or near the inlet.

8. (canceled)

9. A method as claimed in claim 1, wherein the presence of analyte material is detected by measuring a change in: (i) resistance; (ii) impedance; and/or (iii) capacitance.

10. A method as claimed in claim 1, wherein the presence of analyte material is detected using a transmitter-receiver pair such as an LED transmitter and photodiode detector receiver or a pair of ultrasonic transducers.

11-13. (canceled)

14. A method as claimed in claim 1, wherein said step of liberating analyte material from said sample comprises liberating analyte material by an ambient ionisation process.

15. A method as claimed in claim 1, wherein said step of liberating analyte material from said sample comprises liberating analyte material by a rapid evaporative ionisation process.

16. (canceled)

17. (canceled)

18. A system for analysis comprising:
a probe for liberating analyte material from a sample;
a transfer or sampling tube for transferring said liberated analyte material from said sample to an inlet;
an ion analyser situated downstream of said inlet for analysing said analyte material and/or ions derived from said analyte material; and
a device for detecting the presence of said analyte material at a first position and for determining the transit time of said analyte material through at least a part of said sampling or transfer tube using said detection at said first position and optionally a subsequent detection of said analyte material and/or of ions derived from said analyte material.

19. A system for analysis comprising:
a probe for liberating analyte material from a sample;
a transfer or sampling tube as claimed in claim 23 for transferring said liberated analyte material from said sample to an inlet;
an ion analyser situated downstream of said inlet for analysing said analyte material and/or ions derived from said analyte material; and
a device for detecting the presence of said analyte material at a first position within or along said sampling or transfer tube.

20. A system as claimed in claim 18, wherein said ion analyser comprises a mass spectrometer.

21. A system as claimed in claim 18, wherein said probe comprises an ambient ionisation probe.

22. A system as claimed in claim 18, wherein said probe comprises a rapid evaporative ionisation probe.

23. A sampling or transfer tube for interfacing with an inlet of an ion analysis instrument and comprising a device configured to detect the presence of analyte material at a first position within said sampling or transfer tube.

24. A sampling or transfer tube as claimed in claim 23, further comprising a second device for detecting the presence of analyte material at a second position within said sampling or transfer tube.

25. A sampling or transfer tube as claimed in claim 23, wherein said device for detecting the presence of said analyte material comprises a device for measuring resistance and/or impedance.

26. A sampling or transfer tube as claimed in claim 23, wherein said device for detecting the presence of said analyte material comprises a transmitter-receiver pair such as an LED transmitter and photodiode detector receiver or a pair of ultrasonic transducers.

27. (canceled)

28. (canceled)

29. A sampling or transfer tube as claimed in claim 23, wherein said device for detecting the presence of said analyte material comprises a capacitive sensor.

30-32. (canceled)
